(19) United States
(12) Patent Application Publication
(10) Pub. No.: US 2008/0049020 A1
(43) Pub. Date: Feb. 28, 2008

(54) Display Optimization For Viewer Position

(76) Inventors: Carl Phillip Gusler, Austin, TX (US); Rick Allen Hamilton, Charlottesville, VA (US); Brian Marshall O'Connell, Cary, NC (US); Keith Raymond Walker, Austin, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/466,245

(22) Filed: Aug. 22, 2006

(51) Int. Cl. G06T 15/20

(52) U.S. Cl. 345/427

(57) ABSTRACT

A method and implementing computerized system are provided for enhancing a viewing experience by automatically modifying a displayed presentation, such as those used by computer monitors and other related technologies, in response to detected positional attributes of one or more human viewers.

### FIELD OF THE INVENTION

The present invention relates generally to information processing systems and more particularly to a methodology and implementation for enabling an optimization of displayed content in consideration of viewer position relative to a display screen.

### BACKGROUND OF THE INVENTION

Most electronic display systems (including computer monitors, airport flight status displays, active billboards, etc.) require the person viewing them to be in a certain position relative to the display. The viewer is generally required to be positioned directly in front of the center of the display, at a distance comparable to the width of the display, and viewing the display in a line perpendicular to the surface plane of the display. In many common situations, the human viewer is required to move into an optimal viewing position in order to read the display or understand the visual message or content presented on the display. In other words, the viewer must properly position himself relative to the display and the display does not change the displayed presentation content in any way no matter the angle or proximity of the viewer relative to the display device. Although modern display systems contain sophisticated electronics, the typical display system is “dumb” because it assumes that the viewer is in a very specific position, and the system makes no adjustments to compensate for various viewer positions relative to the display screen.

Thus, there is a need for an improved methodology and system for enabling an optimization of display screen presentation in response to viewer position relative to the display screen.

### SUMMARY OF THE INVENTION

A method and implementing computerized system are provided for enhancing a viewing experience by automatically modifying a displayed presentation, such as those used by computer monitors and other related technologies, in response to detected positional attributes of one or more human viewers.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration showing a viewer operating an exemplary desktop computer system;

FIG. 2 is an illustration showing several of the major components of the computer system shown in FIG. 1;

FIG. 3 is an illustration showing an image of a human head relative to an image area or field of view of a digital camera mounted on a display device of the computer system shown in FIG. 1;

FIG. 4 illustrates an exemplary display presentation of a screen of text as may be displayed when a human head is detected as being in the relative camera image field position as shown in FIG. 3;

FIG. 5 shows an image of a human head relative to an image area or field of view of a digital camera mounted on a display device of the computer system shown in FIG. 1;

FIG. 6 illustrates an exemplary display presentation of a screen of text as may be displayed when a human head is detected as being in the relative camera image field position as shown in FIG. 5;

FIG. 7 illustrates an exemplary display screen with viewer position sensors mounted thereon;

FIG. 8 is a flow chart illustrating an operational flow sequence in an exemplary implementation of the present invention;

FIG. 9 is an illustration of a viewer's head moving from a first position relative to a display screen to a second position; and

FIG. 10 shows a display screen presentation when the viewer's head is in the second position shown in FIG. 9.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

An illustrated embodiment of the present invention uses commercially available distance measuring systems including, but not limited to, video camera imaging and image scanning, radar, sonar, laser and other distance determining transceivers. Although the illustrated examples utilize video camera imaging techniques, it is understood that any other distance measuring system may also be implemented without departing from the scope of the present invention.

In accordance with the present invention, an electronic display is enabled for determining or estimating the true position of one or more human viewers. The system is operable for changing the way the displayed content (message or graphic) is presented on the display device so that the viewer or viewers can see the displayed content as best as can be presented for the detected position of the viewer or viewers relative to the display device.

The “smart” display described above has two major capabilities. First, it must determine or estimate the position of the viewing human. Second, it must be able to alter the message so that it can be optimally viewed from that position. In the following description, the word “message” will be used to denote the visual message to be presented to the human viewer. Such a “message” would be expected to include some combination of text and graphics, such as a page from biology textbook or a colorful advertisement. The term “message” is also used interchangeably with “displayed presentation” or “displayed content” all of which refer to content presented on a display screen to one or more viewers. Among other applications, the present invention may be implemented using a computer monitor on a desktop in a home office, or a large retail display, such as at bank or fast-food drive-thru, or a large public display, such as airline display at airport, or an active billboard on a curve along a highway.

In the following examples, the position of the human viewer is first detected or determined. There are a number of methods the smart display can accomplish this. For a computer monitor, the most likely method for identifying a viewer and determining his position would be to have a simple digital camera in or near the display and imaging the room or area where the viewer(s) would be located. Many computer monitors are now equipped with still or video camera accessories, and could be programmed to use consumer digital cameras. Image processing would enable a human viewer to be identified, and their location to be estimated. In one example, a computer monitor is programmed to focus on identifying and positioning human heads. For a large retail display or large public display, the most likely method for determining viewer position uses a simple digital camera in or near the display and imaging the room or area where the viewer(s) is located. Such a large display is programmed to focus on identifying and positioning entire human bodies. An alternative technique for a computer monitor is to estimate the human viewer's position using the position of the computer's accompanying keyboard. For example, a radio frequency identification or RFID tag is placed on the wireless keyboard so that an RFID tag reader connected to the display could locate the keyboard via signal delays, with the human view assumed to be very near the keyboard. The same approach may be used with greater accuracy via a wearable RFID tag. Other methods for determining location include sonar, radar, laser ranging, etc. The position identifier concentrates on distance and viewing angle. An active billboard on a highway might, for example, use a simple radar system to augment or replace a camera-based location finder. An active billboard is then programmed to identify and track vehicles instead of people's heads or bodies.

A second aspect of this invention calculates how to modify the electronic image so that it looks most realistic and is most discernible from the human viewer's position. Distance information is used to appropriately enlarge or “zoom” the message so that all or most of it can be viewed, but at a size that details can be discerned and text read. Angle information is then used to appropriately shape and transform the presentation so that it looks normal when viewed at a detected angle, and not squeezed by perspective. In a simple implementation for desktop computers, the system for determining the human viewer's current position is programmed to update the computer operating system parameters associated with the display. The calculated distance is used to update display resolution, or to change display font sizes for text readability.

More specifically, position information of a viewer relative to a display screen is detected and the display is enabled to respond to how far away that viewer is and increase or decrease the size of what is being displayed. The message being displayed may be an advertisement, flight information, or ordinary text and images, icons or hypertext which may be displayed on a computer display screen. The present invention may also be implemented in any display environment including but not limited to large road-side billboards, flat panel displays and even mobile phone displays.

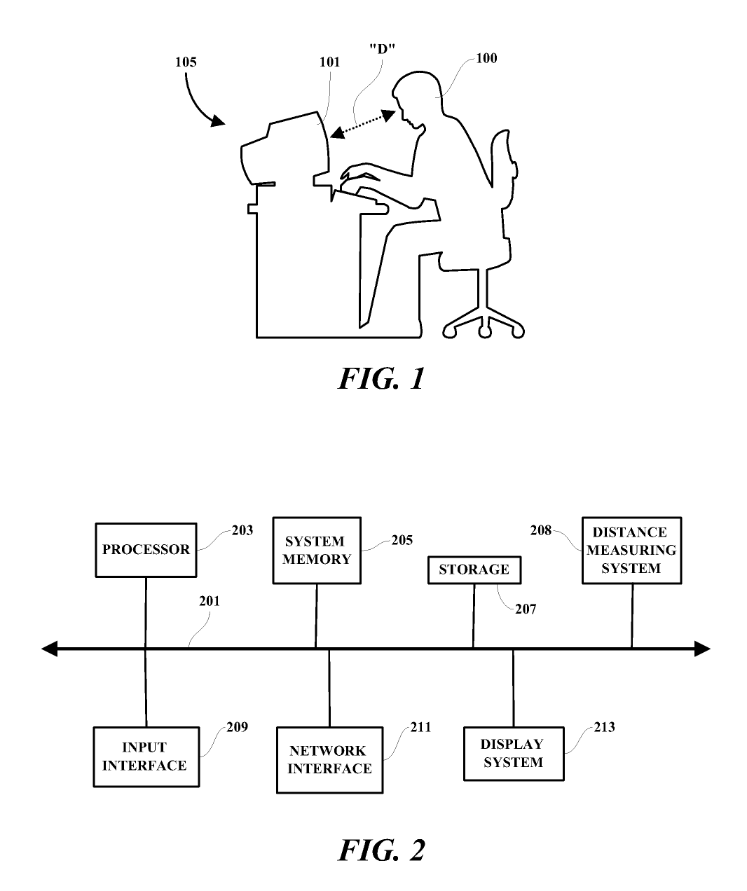

In a desktop computer example as shown in FIG. 1, a user or viewer 100 is viewing a display screen 101 of a computer system 105. The viewer's head is shown positioned at a distance “D” from the display screen 101. The display screen 101 in the example is a CRT display although it is understood that any of many types of available flat panel displays may also be implemented in the computer system 105.

FIG. 2 illustrates several of the major components of the computer system shown in FIG. 1. As shown, the computer system includes, inter alia, a main bus 201 to which is connected a processor 203, system memory 205, system storage 207, and an input interface 209 arranged for connection to a keyboard, keypad, mouse or other input or pointing device. The computer system also includes a network interface 211 for connection to a local or wide area network, and a display system 213 which includes the display screen 101 shown in FIG. 1. Also shown in FIG. 2 is a distance measuring system 208 arranged to measure the distance D between the viewer's head and the display screen 101. The distance measuring system used in the illustrated example includes a digital camera which may be mounted at the top of the display screen and aimed to take a picture of an area directly in front of the display screen. When a viewer is positioned in front of the display screen, the digital camera will obtain an image of the viewer's head among a background including the surroundings of the viewer. Using modern image scanning techniques, the image of the head is isolated from the background and the distance from the display screen to the viewer's head is determined. Other distance measuring systems may also be implemented, including but not limited to, radar, sonar and laser-based systems.

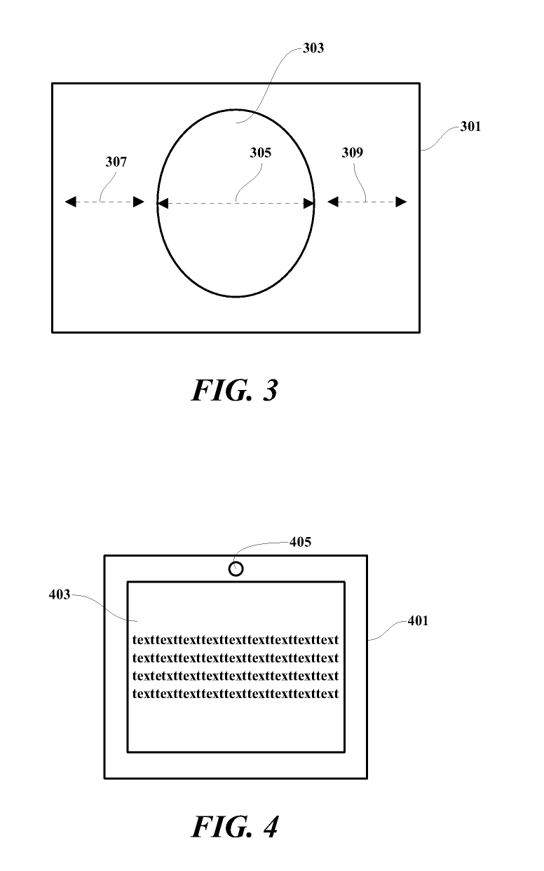

As shown in FIG. 3, the image of a viewer's head 303 is illustrated within a field of view of a digital camera 301 and the distances 307 and 309 between the head and each side of the image frame, as well as the relative size of the head 305, is determined and used in calculating the distance D between the head of the viewer and the display screen. This distance is then used in determining the relative size of the font displayed on the display screen 101.

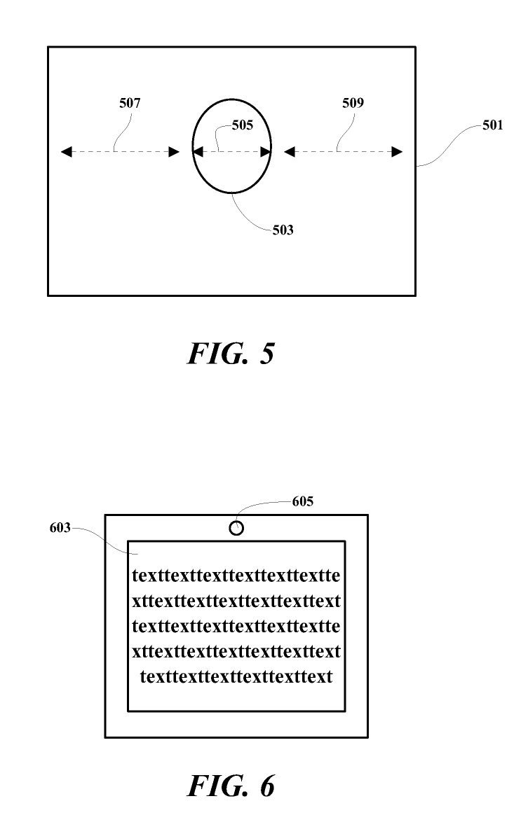

In FIG. 4, a display screen 403 is shown within a housing frame 401. A digital camera 405 is also shown mounted between the display screen 403 and the frame 401 in such a position as to be selectively operated to acquire an image view of objects, including a viewer's head, in front of the display screen 403. In FIG. 3, the viewer's head is relatively close to the display screen and the text presented on the display screen 403 is of a size which is easy to read at the user's detected distance from the display screen. When the digital camera detects that the user has moved his head away from the display screen, an adjustment or modification to the displayed presentation is made as illustrated in FIG. 5 and FIG. 6.

Thus, if a viewer is typing away at work at a normal distance to his or her display screen, and then decides to recline a bit in the viewer's chair, the display determines that the viewer is moving away from it, and therefore begins to adjust the size of objects, such as by decreasing the resolution, for example, a fade from 1280 by 1024 down to 1024 by 768.

In FIG. 5, when the viewer moves his head away from the display screen distance measuring sensor or digital camera, the image of the viewer's head 503 becomes relatively smaller compared to the image collected 501 by the digital camera. As shown, the width of the viewer's head 505 is ascertained and compared to the distances 507 and 509 on each side of the head image. These measurements enable a determination of the distance between the viewer's head and the display screen. When it is determined, for example by image analysis as shown in FIG. 5, that the viewer has moved away from the display screen, the size of the objects being presented on the display screen is automatically increased so that the viewer is able to continue to easily see the displayed presentation at his new position farther away from the display screen. This is illustrated in FIG. 6 which shows the displayed text in a larger font 603 when the viewer is farther away from the display screen or distance sensor 605 than the size of the text 403 (FIG. 4) when the viewer was relatively close to the display screen or distance sensor 405.

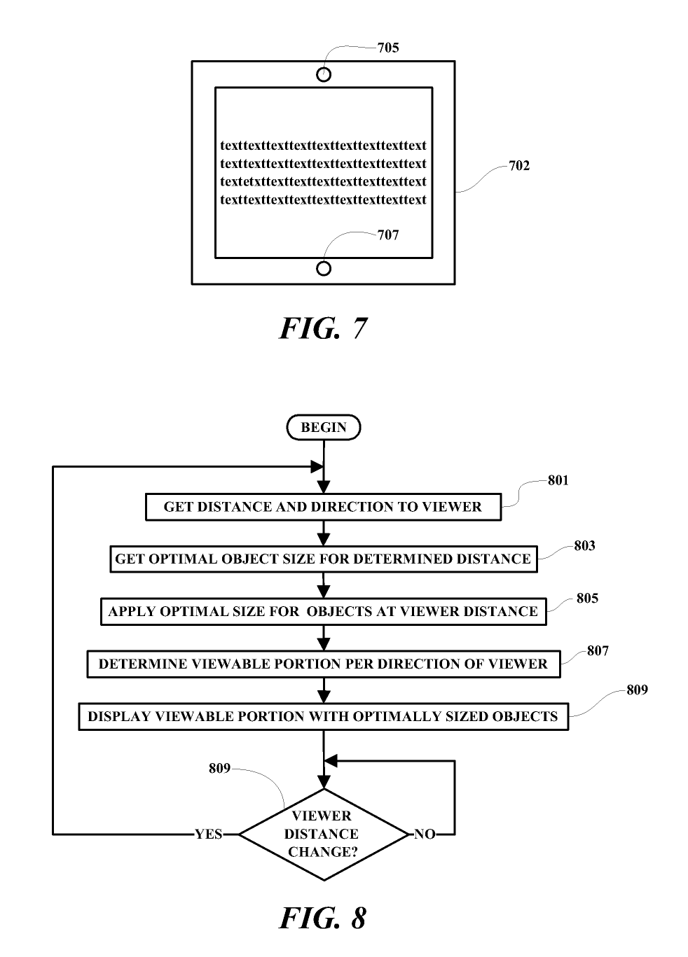

FIG. 7 illustrates other possible mounting locations for the digital camera or distance measuring sensor. As shown, a distance sensor 705 such as a radar, sonar or infrared (IR) transmitter may be mounted on the top border of a display device 702 with a corresponding receiver device 707 mounted on the bottom edge of the display.

As shown in the flow chart of FIG. 8, in one example, the processing begins by obtaining the distance and the direction 801 of the viewer from the distance measuring sensor mounted on a display device. Next, an optimal size is retrieved 803 for the detected distance. This may be accomplished by reference to a table of values for object size vs. distance in which a distance is used to determine sizes of various objects that may be displayed such as text and icons and/or other images. An input graphical user interface (GUI) (not shown) may also be easily implemented to enable a viewer to input to the table to determine the viewer's preferred font sizes relative to the particular viewer's distance away from the display. The GUI would enable each viewer to size various screen elements according to the viewer's ability to see. Next, the determined optimal size of displayed objects for the measured viewer distance away from the display is applied 805. Next, a viewable portion of the display screen is determined 807. This will depend on the detected position or direction of a viewer's head relative to the display screen. The viewable portion of the information to be presented is then displayed 809, and the cycle continues to modify the displayed information in accordance with detected viewer distance changes 809.

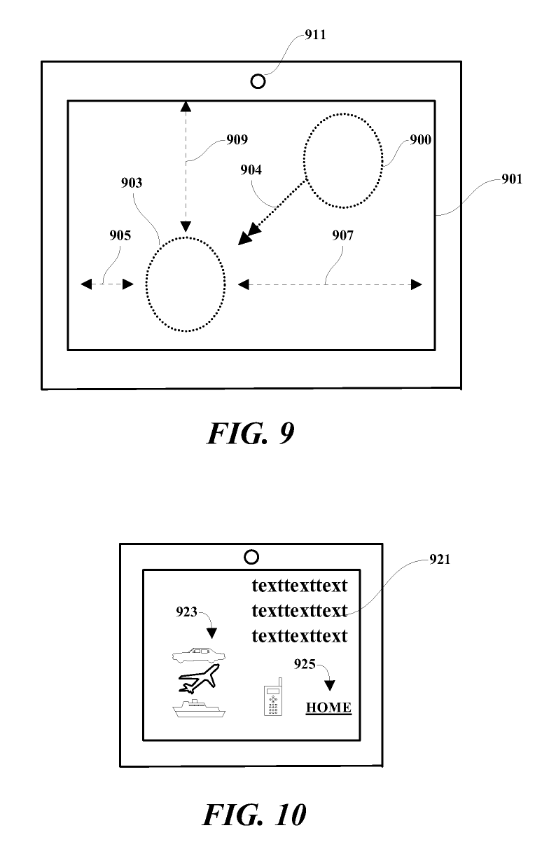

The illustrations of FIG. 9 and FIG. 10 show how displayed information is modified when a viewer changes a position relative to the display screen. As shown when a viewer's head moves 904 from a first position 900 to a second position 903, and the distance from the display screen 901 as detected by the distance measuring digital camera 911, does not change, the various distances 905, 907 and 909 to the edges of the screen are determined and used to provide an indication of where the viewer's head is relative to the screen 901. In response to a detection of the movement of the viewer's head to the second position 903, the focus or particular portion of the total display will also change accordingly. For example, if the user moves his head down and to the left relative to the display screen, the displayed portion of the overall display will also move downwardly and to the left so as to display the lower left-hand portion of the overall display as shown in FIG. 10, including, inter alia, text 921, icons 923 and hypertext objects or links 925, which may not have been displayed when the viewer's head was centered on the display screen.

In operation, the display needs a method to determine or estimate where the viewer is, both distance and viewing angle. A simple digital camera with pattern recognition trained on the human head will work in most cases, and is inexpensive to implement. But for large public displays, the need is a bit different and so the pattern recognition would be on entire human bodies along with fixed reference points so that people heights can be determined and accommodated. Similarly, a billboard would instead track vehicles. As hereinbefore noted, in addition to digital cameras, any other technology that can determine distance can be used, such as sonar, radar, laser, infrared (IR), radio frequency identification (RFID) tags, etc. Manual controls and overrides may also be implemented.

After a display device with a distance measuring sensor has identified viewer position, the image is tailored for that viewer, and, in some case, multiple viewers. The size of the objects within the image is adjusted accordingly. This may be accomplished by zooming objects or by adjusting the entire display's resolution. Another way of modifying a display is by mechanically positioning the display, (e.g. by rotating a display when a viewer is detected as approaching a display device). The characteristics of the message are also adjusted or modified according to viewer angle. To illustrate this simply, imagine a viewer gliding their chair back and forth in front of their display. To keep perspective, when the display is more to the right of the viewer, the side of the display closest to the viewer would need to shrink in size (zoom or resolution), and the side furthest from the viewer would need to increase. Any angle can be accommodated in this fashion, i.e. not just a viewer across a horizontal plane, but at any angle.

When multiple viewers are involved, such as in front of a billboard, there are various options that can be configured according to preference. For example, what is displayed can be targeted to a point between all the viewers (or cars, in this case). Or, it can target a point within the densest cluster of viewers. Or, it can snap back to the default display characteristics. Or, it can morph the position it targets among the various viewers or viewer clusters.

The method and apparatus of the present invention has been described in connection with a preferred embodiment as disclosed herein. The disclosed methodology may be implemented in a wide range of sequences to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for changing visual characteristics of a presentation displayed on a display screen of a display device in response to a position of a viewer relative to said display screen, said method comprising:
detecting a position of said viewer relative to said display screen; and
changing said visual characteristics of said presentation in response to said position of said viewer.

2. The method as set forth in claim 1 wherein said position is detected in terms of distance of said viewer from said display screen.

3. The method as set forth in claim 2 wherein said visual characteristics include size of objects presented on said display screen.

4. The method as set forth in claim 3 wherein said objects include images presented on said display screen.

5. The method as set forth in claim 3 wherein said objects include icons presented on said display screen.

6. The method as set forth in claim 3 wherein said objects include selectable hypertext links presented on said display screen.

7. The method as set forth in claim 1 wherein said position is detected in terms of direction of said viewer from said display screen.

8. The method as set forth in claim 7 a viewable portion of said presentation is determined in response to said direction.

9. The method as set forth in claim 1 and further including a distance measuring system mounted in proximity to said display screen, said distance measuring system being operable for determining a distance said viewer is positioned in front of said display screen.

10. The method as set forth in claim 9 wherein said distance measuring system includes a camera device, said camera device being operable for obtaining an image of said viewer when said viewer in positioned in front of said display screen.

11. The method as set forth in claim 10 wherein said distance measuring system is enabled to detect an image of a head of said viewer, said system measuring system being further enabled to use said image of said head in determining said distance said viewer is positioned in front of said display screen.

12. The method as set forth in claim 10 wherein said distance measuring system is enabled to detect eyes of said viewer, said system measuring system being further enabled to use a position of said eyes in determining said distance said viewer is positioned in front of said display screen.

13. The method as set forth in claim 9 wherein said distance measuring system includes an infrared system, said infrared system being operable for determining said distance said viewer is positioned in front of said display screen.

14. The method as set forth in claim 9 wherein said distance measuring system includes a radar system, said radar system being operable for determining said distance said viewer is positioned in front of said display screen.

15. The method as set forth in claim 9 wherein said distance measuring system includes a sonar system, said sonar system being operable for determining said distance said viewer is positioned in front of said display screen.

16. The method as set forth in claim 9 wherein said distance measuring system includes a laser system, said laser system being operable for determining said distance said viewer is positioned in front of said display screen.

17. The method as set forth in claim 9 wherein said distance measuring system includes a radio frequency identification (RFID) tag system, said RFID tag system being operable for determining said distance said viewer is positioned in front of said display screen.

18. The method as set forth in claim 1 wherein said display screen is part of a personal computer system, said display screen being designed to be viewed by one viewer.

19. The method as set forth in claim 1 wherein said display screen comprises a large scale display screen designed to be viewed by a plurality of viewers.

20. A programmed medium, said programmed medium being programmed to operate with a computer system to provide program signals within said computer system for changing visual characteristics of a presentation displayed on a display screen of a display device in response to a position of a viewer relative to said display screen, said program signals being selectively operable for:
enabling a detection of a position of said viewer relative to said display screen; and
enabling a changing said visual characteristics of said presentation in response to said position of said viewer.

21. A display system comprising:
a display screen arranged for displaying a visual presentation to one or more viewers;
a position detection system coupled to said display screen and arranged in proximity to said display screen, said position detection system being operable for detection of a position of said one or more viewers relative to said display screen; and
processing means coupled to said position detection system and said display screen, said processing means being operable for changing visual characteristics of said presentation in response to said position of said one or more viewers.
